(19) United States
(12) Patent Application Publication
(10) Pub. No.: US 2009/0211207 A1
(43) Pub. Date: Aug. 27, 2009

(54) Horse-Drawn Carriage

(76) Inventor: James A. Kelly, Dublin (IE)

Correspondence Address: KUSNER & JAFFE;HIGHLAND PLACE SUITE 310, 6151 WILSON MILLS ROAD, HIGHLAND HEIGHTS, OH, 44143, US

(21) Appl. No.: 11/988,398

(22) PCT Filed: Jul. 6, 2006
(86) PCT No.: PCT/IE2006/000071

§ 371 Date: Apr. 23, 2009

(30) Foreign Application Priority Data
Jul. 7, 2005 (IE) S2005 0454

(51) Int. Cl. B62C 5/00; B62C 1/00; B68C 1/00

(52) U.S. Cl. 54/39.1; 280/63

(57) ABSTRACT

A horse-drawn carriage 50 comprises a wheeled chassis 58, a boom 40 for drawing the carriage and a linkage mechanism 46, 51-56 which connects the boom 40 to the chassis 58. The boom has a seat 45 for a rider. The linkage mechanism 46, 51-56 permits movement between the chassis 58 and the boom 40 and includes a shock absorber 55 which acts between the chassis 58 and the boom 40. The linkage mechanism can permit rotational movement of the chassis with respect to the boom 40. A harness arrangement comprises a hitch 12 for coupling to the boom, the hitch being mounted to the harness such that the hitch can move in a direction substantially aligned with, or parallel to, the horse's back with tensioning means 34, 35 restricting movement of the hitch. The harness arrangement can reduce jolting to both the horse and the rider, resulting in a smoother drive.

### FIELD OF THE INVENTION

The present invention relates to a horse drawn carriage and to a harness arrangement for drawing a horse-drawn carriage.

### BACKGROUND TO THE INVENTION

Horse-drawn carriages have been used throughout the ages. The carriage, which is often called a sulky, buggy or trap, is typically a simple structure with two wheels, a seat or platform for the rider, and a hitch to connect the carriage to a horse. The hitch can comprise two parallel shafts which extend forwardly from each side of the carriage, each shaft lying alongside a respective side of the horse. The shafts are connected to a harness mounted about the horse. An alternative hitch comprises a single shaft which is mounted over the horse's back and which connects to the neck of the horse, or to a harness mounted over the horse's back. A hitch of this kind is described in U.S. Pat. No. 5,076,041 and U.S. Pat. No. 5,410,863 and permits a greater degree of movement between the horse and carriage compared to the two-shaft hitch.

In U.S. Pat. No. 5,076,041 the carriage has a wheeled chassis, with suspension springs acting between the chassis and the wheels. A seat for the rider is mounted to rear risers on the chassis. A separate suspension acts between the boom and the chassis. The suspension springs provide dampening as the carriage rides over an undulating surface and the suspension between the boom and chassis serves to isolate the rider from movement of the horse. One disadvantage of this arrangement is that the suspension springs provide only a limited degree of isolation between the rider and an undulating surface. A further disadvantage of this arrangement is that the position of a pivot and suspension between the boom and the chassis can cause the rider to be rocked forward and aft.

The present invention seeks to provide an improved ride to a rider of a horse-drawn carriage.

### SUMMARY OF THE INVENTION

A first aspect of the present invention provides a horse-drawn carriage comprising:

a wheeled chassis;

a boom for drawing the carriage, the boom having a seat for a rider; and,

a linkage mechanism which connects the boom to the chassis, the linkage mechanism being arranged to permit movement between the chassis and the boom and including a shock absorber which acts between the chassis and the boom.

A carriage of this kind has an advantage of providing a higher degree of isolation between a rider and an undulating surface over which the carriage travels. Mounting a seat for the rider on the boom itself has been found to offer a better transfer of feedback from the horse, whether the horse is loping, cantering or galloping and can deliver a sensation akin to that of riding a horse. Mounting the seat in this way also gives a rider a greater sense of security as they can grip the boom with their legs and thighs, shifting their weight around as necessary to counter the forces experienced during the ride, while leaving the rider's hands free to control the reins. Preferably the linkage mechanism permits movement in a plane perpendicular to a base of the chassis.

Preferably the linkage mechanism comprises a first supporting arm which is mounted to the boom at a first end and a second supporting arm which is mounted to the chassis at a first end with the first and second supporting arms being pivotably connected to one another at their second ends. This type of mechanism has been found to offer a particularly high degree of isolation.

Preferably the linkage mechanism permits rotational movement of the chassis with respect to the boom. This can allow the chassis to rotate about the axis of the boom as the chassis passes over a surface which causes one wheel to rise higher than the other. A seated rider can remain upright under these conditions and the horse experiences reduced stress. Similarly, if a horse were to fall, the boom is free to rotate with respect to the chassis so that the chassis can remain upright. This rotational movement can be achieved by providing the linkage mechanism with a sleeve which surrounds a portion of the boom, and which permits relative rotation between the sleeve and boom. Although the sleeve should permit relative rotation, it is desirable that the sleeve should not slide along the boom. This can be achieved by forming a portion of the boom with a narrowed cross-section and an hour-glass profile. The sleeve can act around the narrowed cross-section and is prevented from moving along the boom by the shoulders of the boom on each side. Alternatively, retaining collars mounted around the boom, or equivalent mechanisms, can be provided to prevent the sleeve from slipping along the boom.

Preferably, the boom is connected to a harness arrangement which comprises: a harness for mounting to a horse; a hitch for coupling to the boom, the hitch being mounted to the harness such that the hitch can move in a direction substantially aligned with, or parallel to, the horse's back; and tensioning means for restricting movement of the hitch. The harness arrangement can reduce jolting to both the horse and the rider, resulting in a smoother drive.

The carriage can be used for a wide range of activities, such as a training aid for long reining horses, in dressage driving or for general transport of a passenger. With minor modification to provide a load-bearing floor or goods housing, the carriage can be used to carry goods.

A further aspect of the present invention provides a harness arrangement for pulling a load comprising:

a harness for mounting to a horse;

a hitch for coupling to a boom for drawing the load, the hitch being mounted to the harness such that the hitch can move in a direction substantially aligned with, or parallel to, the horse's back; and

tensioning means for restricting movement of the hitch.

This type of harness arrangement has been found to reduce jolting to both the horse and the rider, resulting in a smoother drive.

The movement of the hitch can be achieved by slideably mounting the hitch within a box which is connected to the harness, the box containing movement of the hitch to a direction which is substantially aligned with, or parallel to, the horse's back.

Preferably, a part of the hitch which fits within the box and/or an inner surface of the box have a low friction coating to ease movement of the hitch.

The tensioning means can take the form of a spring mounted within the box and positioned between the hitch and an end of the box. Preferably, the tensioning means comprises a first spring connected between the hitch and a first end of the box and a second spring connected between the hitch and a second end of the box such that the springs, in a steady state, bias the hitch into a position centrally within the box. Alternatively, where no box is present, the tensioning means can act between the hitch and another point on the harness.

The load preferably comprises a wheeled carriage but can take other forms. Preferably there is a single mounting hitch, which is positioned on the harness such that it rests, in use, above the central line of the horse's back. This allows a load to have a greater freedom of movement. Alternatively, several of the mounting hitches can be distributed about the horse's back, such as one mounting hitch on each side of the horse's back.

### BRIEF DESCRIPTION OF THE DRAWINGS

The invention will be more clearly understood from the following description of an embodiment thereof, given by way of example only, with reference to the accompanying drawings, in which:

FIG. 1 shows a carriage and harness arrangement according to an embodiment of the present invention;

FIG. 2 shows the harness arrangement of FIG. 1 in more detail;

FIGS. 3 and 4 show a slide box which houses a ball hitch;

FIG. 5 shows a saddle skeleton;

FIG. 6 shows a saddle pad for fitting over the saddle skeleton of FIG. 5;

FIG. 7 shows a frame of the carriage of FIG. 1;

FIG. 8A shows the boom in more detail;

FIG. 8B shows one of the plates used to mount the boom to the linkage mechanism;

FIG. 9 shows the chassis of the carriage of FIG. 1;

FIG. 10 shows a cradle frame which fits to the chassis of the carriage; and,

FIG. 11 shows an alternative embodiment of the slide box.

### DETAILED DESCRIPTION OF THE DRAWINGS

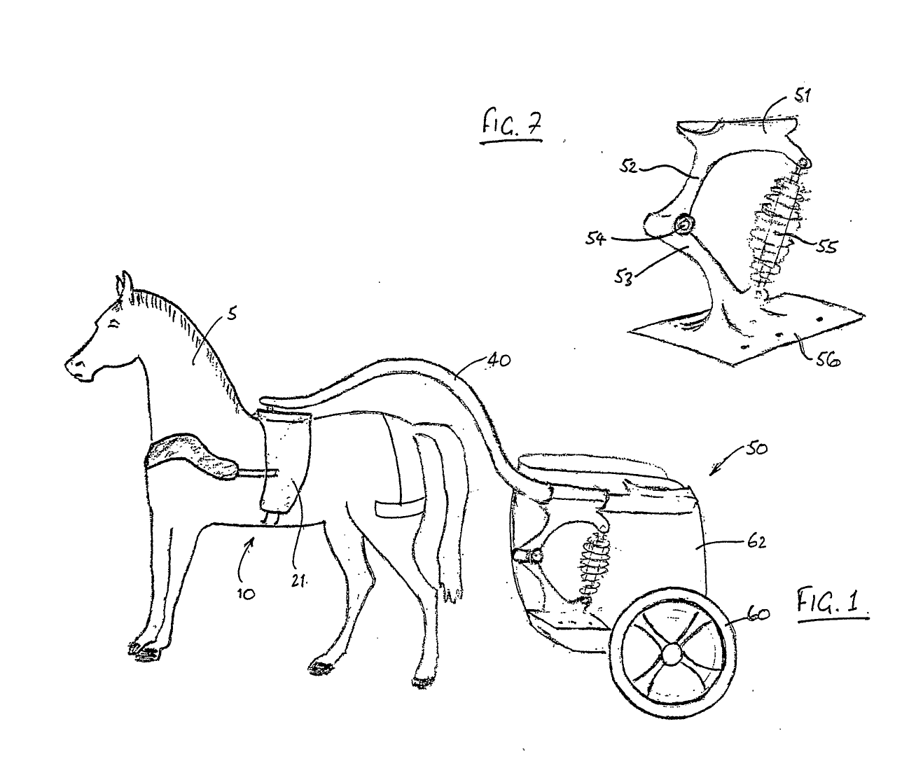

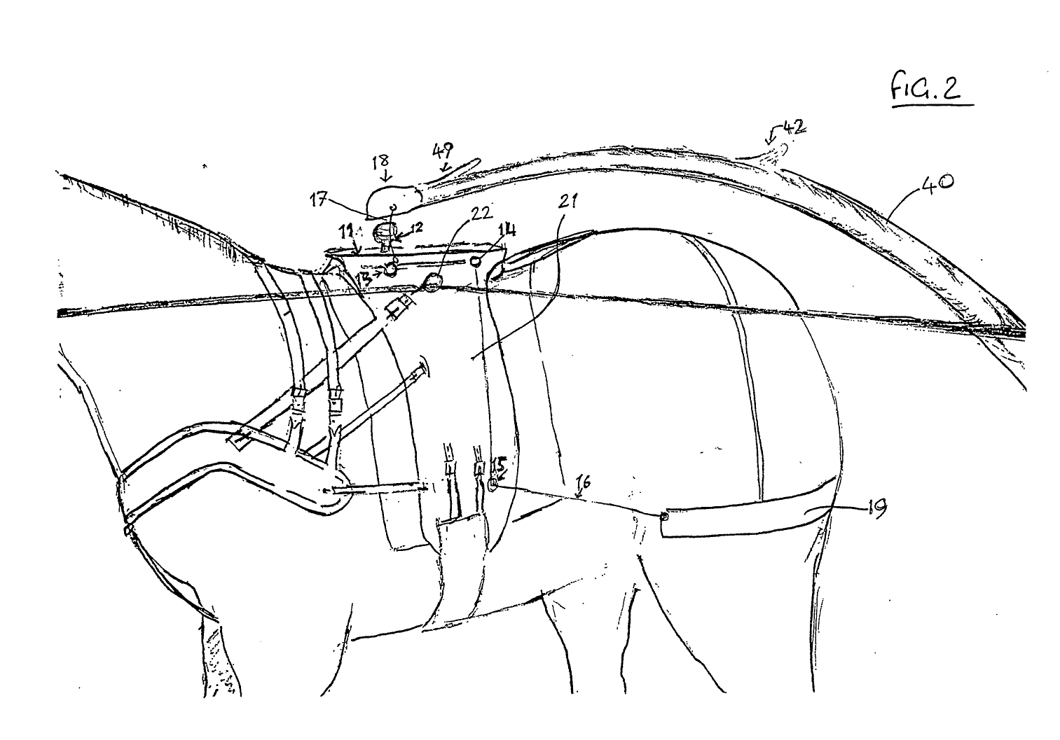

FIG. 1 shows a side-view of a carriage 50 and a harness arrangement according to an embodiment of the present invention. The carriage 50 is shown partially cut-away to reveal the structure of the carriage. FIG. 2 shows the harness arrangement in more detail.

A harness arrangement 10 attaches to horse 5. The harness includes a saddle 21 which sits on the back of the horse. An upper face of the saddle 21 supports a ball hitch 12 having a spherical shape. The ball hitch 12 is mounted within a slide box 11. A coupling 18 is connected to one end of a boom 40 for drawing carriage 50. Coupling 18 has a generally hemispherical socket (not shown) for receiving the ball hitch 12. The coupling 18 locks to the ball hitch 12 and allows the boom 40 to freely rotate about the ball hitch 12 in a plane parallel with the ground surface (to accommodate movements as the horse turns) and a limited degree of movement about the ball hitch in a plane perpendicular to the ground surface (to accommodate movements as the horse rises and falls). However, the coupling 18 is prevented from lifting (separating) from the ball hitch 12. A locking lever 9 is provided to disconnect the coupling 18 from the hitch 12. Typically, the locking of coupling 18 about ball hitch 12 is achieved by providing coupling 18 with a member which protrudes beneath the ball and which serves to prevent coupling 18 from lifting. Operating lever 9 releases this member and allows the coupling 18 to be lifted clear of the ball hitch 12. A safety chain 17 connects between coupling 18 and slide box 11 and serves to provide a linkage between these parts in the event that the coupling 18 becomes detached from ball hitch 12.

Various straps secure saddle 21 to the horse 5. These include straps which attach forwardly of the saddle, around the forward part of the horse, and a breeching 19 which passes around the haunches of the horse 5. Reins are attached to the head of the horse and pass through a ring 22 on the saddle 21.

A first embodiment of the slide box 11 is shown in more detail in FIGS. 3 and 4. The slide box 11 comprises a tubular member 31 with a generally C-shaped cross-section. Member 31 has a base 31a, side walls 31b and, on the upper face, a pair of flanges 31c, each flange 31c extending inwardly from a respective side wall 31b. The flanges 31c define a central slot along which a shaft of the hitch 12 can pass. The C-shaped member 31 defines a channel along which the lower part 32 of the hitch can slide. Sliding movement is aided by providing low-friction surfaces (rails 33, 38) on the inside faces of member 31 and by providing a sleeve over part 32 from a material such as Nylon. Nylon has been found to be particularly hard-wearing. In a direction 26 movement of the hitch part 32 within the slide box 11 is constrained by the flanges 31c which define the slot in the upper surface of the slide box 11. In a direction 27 (i.e. aligned along the central line of the horse) movement of the hitch part 32 within the slide box 11 is constrained by springs 34, 35. Each spring 34, 35 fits within the channel inside member 31 and is trapped between an end face of hitch part 32 and an end wall of the slide box 11. The force of each spring is adjustable by tensioning adjusters 36, 37. Slide box 11 is preferably formed of a strong, lightweight material such as aluminum.

At rest, hitch 12, 32 normally adopts a position which is generally central within slide box 11, as shown in FIG. 3. As the horse moves from rest the hitch 12 moves rearwardly (towards the right in FIG. 3), causing spring 34 to compress and spring 35 to extend. When a steady speed is reached the hitch 12 returns to a more central position, aided by the restoration forces exerted by springs 34, 35. Rather than directly transmitting movement of the horse to boom 40 and carriage 50, the slide box allows some movement of the horse with respect to the boom 40 and carriage 50 which ensures a smoother transition. As the horse slows down the hitch again moves within slide box 11. Hitch 12 moves forwardly (towards the left in FIG. 3) as the horse brakes, causing spring 35 to compress and spring 34 to extend. Upon reaching a steady state again, such as a constant speed or coming to a stop, the hitch 12 again returns to a more central position, aided by the restoration forces exerted by springs 34, 35.

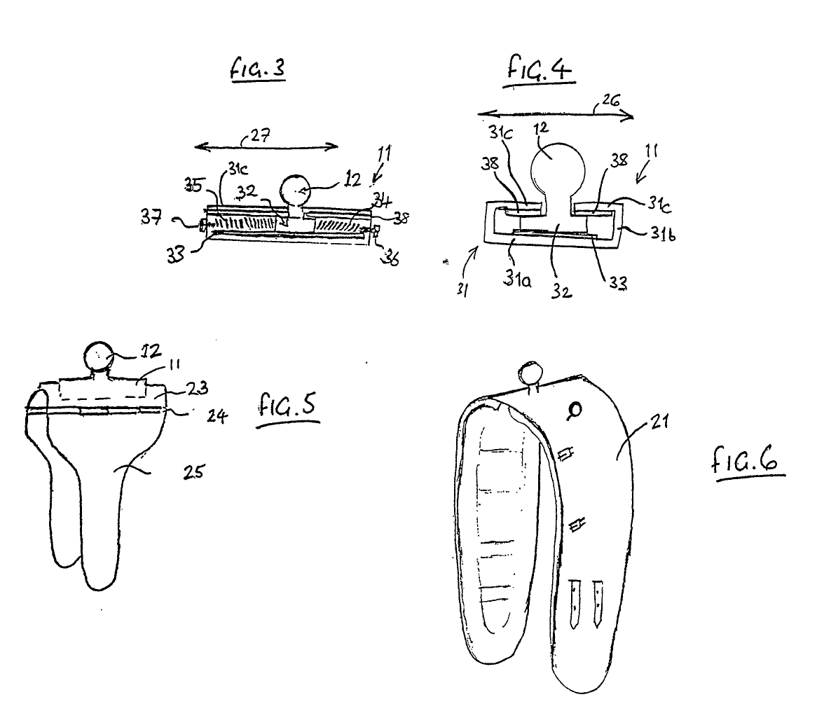

FIGS. 5 and 6 show the construction of the saddle. The saddle comprises a skeleton, shown in FIG. 5, with a saddle pad (FIG. 6) which fits over the skeleton. The skeleton comprises three main parts: a central part 23 which sits over the back of the horse and two side panels 25 which lie alongside the horse. The side panels 25 are each hinged 24 to a respective side of the central part 23 to allow greater flexibility.

The slide box 11 as previously described is housed within the central part 23 or is formed integrally with the central part 23. Preferably, side panels 23, 25 of the skeleton are formed of carbon fibre. A saddle pad, which is preferably formed of leather, fits over the skeleton shown in FIG. 5 and carries securing straps and rings for accommodating reins and control cords. Additionally, rubber pads (not shown) positioned between the saddle and the horses back can provide extra cushioning means to absorb any shocks when the horse and the carriage are subjected to any sudden movements.

Returning to FIG. 1, this shows a further feature of the harness which helps to brake the horse. A cord 16 extends between the ball hitch 32 within slide box 11 and the breeching 19. A steel ring 13 is attached to ball hitch 32 and, in use, pulls cord 16 to apply a force around the horse's haunches when the boom moves forward with respect to the harness.

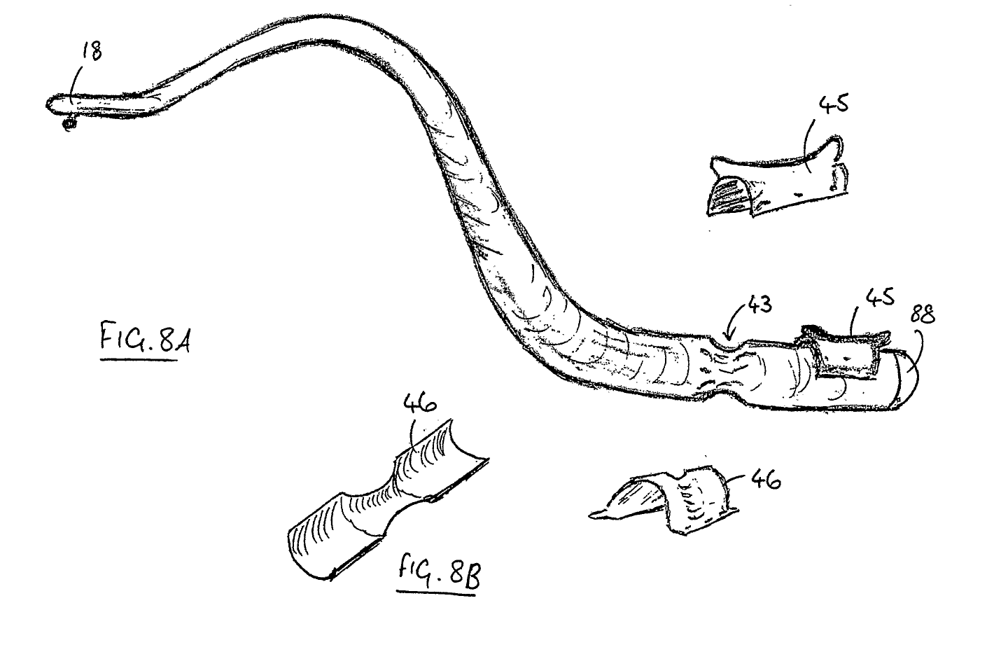

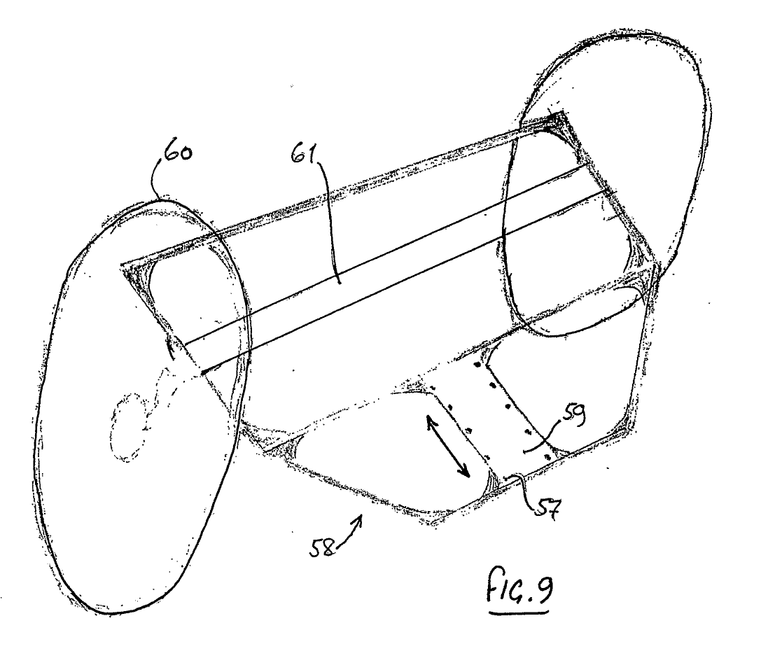

The carriage 50 is connected to the horse by a boom 40, shown in FIG. 8A. The purpose of the boom 40 is to transmit movement of the horse to the carriage 50. One end of the boom 40 carries a coupling 18 which has been previously described. The other end of the boom 40 carries a seat 45 upon which a rider can sit. Seat 45 can be secured directly to boom 45, such as fixings which are mounted through holes in the boom 40, by clamping around boom 40, or by any other suitable means. Boom 40 should be sufficiently strong to directly support the weight of one or more riders. It has been found that the provision of a seat on the boom 40 advantageously provides a riding sensation similar to that of being in the saddle.

Boom 40 connects to the carriage 50 about a portion 43 of boom 40. Portion 43 of the boom has a narrowed cross-section and has a generally hour-glass profile when viewed from the side. The shoulders of the hour-glass portion 43 have been found to prevent the boom from slipping with respect to the mounting sleeve under severe traction. It is preferred to form the boom 40 from carbon fibre because it is lightweight, very strong and flexible. This adds suppleness to the drive. One example embodiment of the boom has a tubular cross-section of an oval shape, with a 180 mm width and 140 mm depth and walls of 10 mm thickness. The coupling 18 is preferably made of steel (hardened). The overall shape of the boom is designed with comfort in mind for both horse and rider. The continuous smooth curve from carriage to horse's back, together with the elongated oval cross-section increase safety. In the event of a crash, where the rider is thrown forward from the carriage, the lack of sharp corners or edges should minimise injury. The shape of the boom provides leverage which helps to lessen weight of the carriage from the horse's back. The use of a single boom 40 allows a greater freedom of movement compared to traditional two-shaft hitches, allowing turns at sharper angles (e.g. 45 degrees), walking, trotting, cantering, and galloping with greater ease and comfort for both horse and rider. A removable end cap 88 in the end of the boom nearest the saddle 45 permits access to a storage cavity within the boom. This cavity can have a depth of, for example, 60 cm or so. The cavity can be filled with weights, if it is desired to work the horse harder, or it can be used to store tools or other objects.

The carriage 50 will now be described with respect to FIGS. 1, 7, 9 and 10. The main parts of carriage 50 are a monoframe, a chassis and a cradle frame. The monoframe comprises two arms 52, 53 which are pivotably mounted to one another at point 54. Lower arm 53 extends in a plane perpendicular to a base plate 56 and is inclined forwardly with respect to base 56, towards a pivot point 54. Upper arm 52 is inclined rearwardly of the pivot point 54 and lies in the same plane, perpendicular to the base plate 56. Upper arm 52 supports sleeve 51 which is shaped to receive portion 43 of the boom 40, as previously described. To assemble the carriage 50 to the boom 40, portion 43 of the boom is first laid within sleeve part 51. A further sleeve part 46 is laid over the first sleeve part 51. FIG. 8B shows the underside of the sleeve part 46, the central part of which has a profile corresponding to the narrowed portion 43 of the boom 40. The sleeve parts 46, 51 are then secured to one another. The sleeve does not firmly grasp portion 43 of the boom but rather allows the boom to rotate within the sleeve. This allows the chassis to rotate with respect to the boom as the chassis passes over an undulating surface and similarly allows the boom to rotate with respect to the chassis if the horse moves from side to side or were to fall sideways. The further sleeve part 46 can be secured using steel pins and fasteners or any other kind of fastener. It is preferred that the fasteners are quick release fasteners such that the carriage 50 and boom 40 can quickly be disassembled from one another. A rubber sleeve fits between the sleeve parts 46, 51 and boom portion 43 to permit rotational movement. Alternatively, a lubricant, low-friction coating or material of low-friction can be fitted between the sleeve 46, 51 and boom 43. Lower arm 53 is connected to a base plate 56 which is mounted to the chassis 58. A shock absorber 55 acts between the non-pivoted ends of the arms 52, 53 and serves to maintain the arms in the spaced-apart configuration shown in FIG. 7. In use, movement of the horse and movement of the chassis over an undulating surface will cause arms 52, 53 to pivot towards or away from one another. Movement of the arms 52, 53 is restricted (dampened) by shock absorber 55. Preferably, the arms 52, 53 are made of a strong, lightweight material such as aluminum.

The monoframe is secured to a chassis 58 as shown in FIG. 9. The chassis 58 is preferably a strong, lightweight frame formed from material such as aluminum. A plate 59 has a set of holes 57 positioned along each side. These holes 57 serve as mounting points for the base plate 56 of the monoframe. The base plate 56 can be secured to the plate 59 by a set of bolts and wing nuts, or similar fixings. In this example there are six mounting points, but there is a larger number of holes 57 spaced along plate 59 such that the base plate 56 can be secured at various positions along plate 59. This allows the carriage to accommodate riders of different sizes. An axle 61 is mounted to the chassis via suspension mountings. Wheels 60 are fixed to the axle 61. Alternatively, the suspension mountings can be omitted and the suspension 55 can serve as the sole suspension for the carriage.

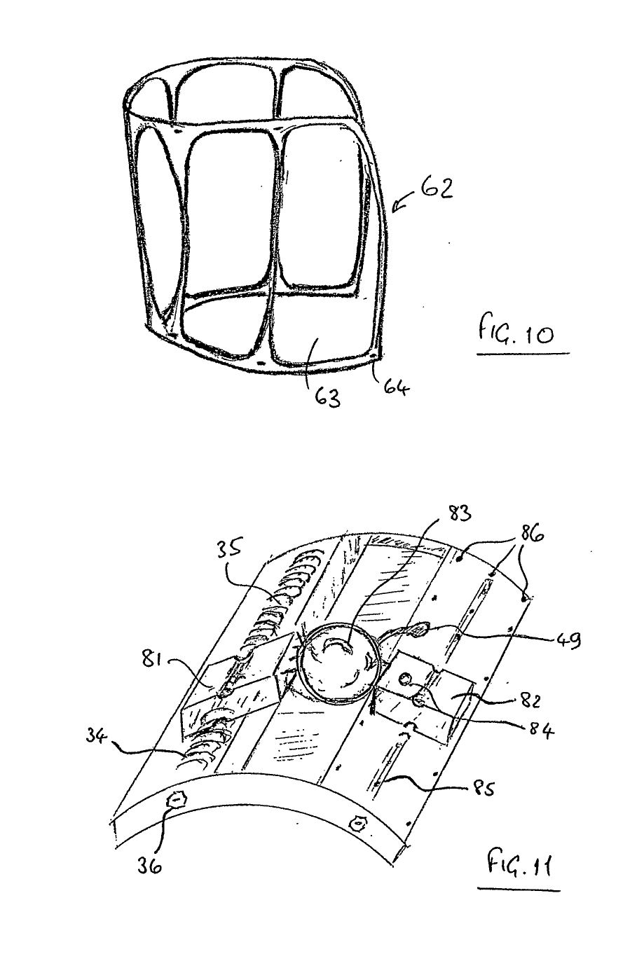

A cradle frame 62, shown in FIG. 10, is secured to the chassis and serves to protect the rider from overgrowth, hanging branches, mud splashes etc. and also helps to give the rider a sense of security. The cradle flame can be formed from a lightweight material such as aluminum, carbon fibre or plastic. The cradle flame can retain panels 63 made of a flexible and lightweight material (e.g. canvas or plastic) or solid sheeting such as aluminum. Alternatively, a flexible apron can be fitted around the frame 62. Preferably the frame 62 is formed as two half U-shaped sections so that it can be taken apart very quickly. Lugs 64 locate with complementary fixings on the chassis 58.

In the embodiment shown in FIG. 1 the ball hitch 12 protrudes from the slide box 11 mounted on the top of the saddle. In an alternative embodiment shown in FIG. 11 the position of the ball and socket are reversed, with an inverted ball hitch fitted to the end of boom 40 (as shown in FIG. 8A) and a socket 83 mounted within the slide box. This alternative arrangement is more pleasing to look at, particularly when the saddle is fitted to the horse and the boom is detached, since the ball hitch does not protrude from the top of the saddle. In this alternative embodiment of the slide box the socket 83 is mounted within a central channel and is connected to a block 81, 82 on each side. The slide box, when assembled, has the same generally C-shaped cross-section. Springs 34, 35 act upon the blocks 81, 82 in the same manner as previously described, to counter forces as the horse accelerates and decelerates. Blocks 81, 82 slide upon Nylon rails 85 and similar rails are mounted on a cover plate which fits to the top face of the slide box. The cover plate secures to mounting holes 86. One, or both, of blocks 81, 82 has a vertically directed hole. The cover plate has a similar hole, aligned with the path of the block. In use, a locking pin can be passed through the cover plate and into the block 81 to lock the position of the socket. This can be used if, for example, one of the springs is faulty.

It will be appreciated that the shape of the boom of the present invention aids in balancing both the rider and the carriage so that the boom can pivot on the harness arrangement while the weight of a rider on the carriage keeps the boom upright and balanced to provide comfort to both the horse and the rider.

The words “comprises/comprising” and the words “having/including” when used herein with reference to the present invention are used to specify the presence of stated features, integers, steps or components but does not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The invention is not limited to the embodiments hereinbefore described but may be varied in both construction and detail.

1. A horse-drawn carriage comprising:
a wheeled chassis;
a boom for drawing the carriage, the boom having a seat for a rider; and,
a linkage mechanism which connects the boom to the chassis, the linkage mechanism being arranged to permit movement between the chassis and the boom and including a shock absorber which acts between the chassis and the boom.

2. A horse-drawn carriage according to claim 1 wherein the linkage mechanism permits movement in a plane perpendicular to a base of the chassis.

3. A horse-drawn carriage according to claim 1 wherein the linkage mechanism comprises a first supporting arm which is mounted to the boom at a first end, a second supporting arm which is mounted to the chassis at a first end, the first and second supporting arms being pivotably connected to one another at their second ends.

4. A horse-drawn carriage according to claim 1 wherein the linkage mechanism comprises a first supporting arm which is mounted to the boom at a first end, a second supporting arm which is mounted to the chassis at a first end, the first and second supporting arms being pivotably connected to one another at their second ends, and the shock absorber connects between a point on the boom which is adjacent the first end of the first supporting arm and a point on the chassis which is adjacent the first end of the second supporting arm.

5. A horse-drawn carriage according to claim 1 wherein the linkage mechanism permits rotational movement of the chassis with respect to the boom.

6. A horse-drawn carriage according to claim 1 wherein the linkage mechanism permits rotational movement of the chassis with respect to the boom and the linkage mechanism comprises a sleeve which surrounds a portion of the boom.

7. A horse-drawn carriage according to claim 1 wherein the linkage mechanism permits rotational movement of the chassis with respect to the boom and the linkage mechanism comprises a sleeve which surrounds a portion of the boom, and the sleeve surrounds a portion of the boom which has a narrowed cross-section.

8. A horse-drawn carriage according to claim 1 wherein the linkage mechanism permits rotational movement of the chassis with respect to the boom and the linkage mechanism comprises a sleeve which surrounds a portion of the boom, said sleeve comprises two parts which are separable, in use, to allow the boom to be removed from the remainder of the carriage.

9. A horse-drawn carriage according to claim 1 wherein the seat is mounted at a distal end of the boom.

10. A horse-drawn carriage according to claim 1 wherein the boom is made of carbon fibre.

11. A horse-drawn carriage according to claim 1 further comprising a frame mounted to the chassis which extends around the perimeter of the chassis to support a shield.

12. A horse-drawn carriage according to claim 1 further comprising a harness arrangement for drawing the carriage which comprises:
a harness for mounting to a horse;
a hitch for coupling to the boom, the hitch being mounted to the harness such that the hitch can move in a direction substantially aligned with, or parallel to, the horse's back; and
tensioning means for restricting movement of the hitch.

13. A harness arrangement for pulling a load comprising:
a harness for mounting to a horse;
a hitch for coupling to a boom for drawing the load, the hitch being mounted to the harness such that the hitch can move in a direction substantially aligned with, or parallel to, the horse's back; and
tensioning means for restricting movement of the hitch.

14. A harness arrangement according to claim 13 wherein the hitch is slideably mounted within a box which is connected to the harness, the box constraining movement of the hitch to a direction which is substantially aligned with, or parallel to, the horse's back.

15. A harness arrangement according to claim 13 wherein the hitch is slideably mounted within a box which is connected to the harness, the box constraining movement of the hitch to a direction which is substantially aligned with, or parallel to, the horse's back, and said hitch comprises a first portion, which connects to the boom, and a second portion which lies within a channel within the box, the second portion being held captive within the channel by flanges extending partly across the width of the upper face of the box.

16. A harness arrangement according to claim 13 wherein the hitch is slideably mounted within a box which is connected to the harness, the box constraining movement of the hitch to a direction which is substantially aligned with, or parallel to, the horse's back and at least part of the outer surface of the hitch has a low friction coating.

17. A harness arrangement according to claim 13 wherein the hitch is slideably mounted within a box which is connected to the harness, the box constraining movement of the hitch to a direction which is substantially aligned with, or parallel to, the horse's back, said channel comprises at least one rail along which the hitch can slide, the rail having a low friction coating.

18. A harness arrangement according to claim 13 wherein the hitch is slideably mounted within a box which is connected to the harness, the box constraining movement of the hitch to a direction which is substantially aligned with, or parallel to, the horse's back and wherein the tensioning means comprises a spring connected between the hitch and an end of the box.

19. A harness arrangement according to claim 13 wherein the tensioning means comprises a first spring connected between the hitch and a first end of the box and a second spring connected between the hitch and a second end of the box.

20. A harness arrangement according to claim 13 wherein the hitch is connected to a breeching part of the harness such that movement of the hitch in a forward direction applies pressure to the breeching.

21. A harness arrangement according to claim 13 wherein there is a single hitch mounted on the harness such that, in use, the hitch sits on the central line of the horse's back.
